(19) United States
(12) Patent Application Publication
(10) Pub. No.: US 2026/0204153 A1
(43) Pub. Date: Jul. 16, 2026

(54) METHOD FOR PROCESSING TRAJECTORY DATA

(71) Applicant: BEIJING BAIDU MAPPING TECHNOLOGY CO., LTD., BEIJING (CN)

(72) Inventors: Kun YANG, BEIJING (CN); Bin WU, BEIJING (CN); Xiyan LIU, BEIJING (CN); Tongbin ZHANG, BEIJING (CN); Jianzhong YANG, BEIJING (CN); Zhen LU, BEIJING (CN)

(73) Assignee: BEIJING BAIDU MAPPING TECHNOLOGY CO., LTD., BEIJING (CN)

(21) Appl. No.: 19/562,471

(22) Filed: Mar. 10, 2026

(30) Foreign Application Priority Data
Mar. 18, 2025 (CN) 202510322948.7

(51) Int. Cl. G08G 1/01; G08G 1/052

(52) U.S. Cl. CPC G08G 1/0133; G08G 1/0112; G08G 1/052

(57) ABSTRACT

A method is provided. An implementation solution includes: obtaining trajectory data; obtaining a first distribution encoding of the target road segment and a speed encoding of the target road segment based on the trajectory data; and obtaining a target detection result based on the first distribution encoding and the speed encoding, where the target detection result is used to indicate whether a target road event occurs in the target road segment.

### CROSS REFERENCE TO RELATED APPLICATION

This application claims priority to Chinese patent application No. 202510322948.7 filed on Mar. 18, 2025, the contents of which are hereby incorporated by reference in their entirety for all purposes.

### TECHNICAL FIELD

The present disclosure relates to the technical field of artificial intelligence, and in particular, to technical fields such as map navigation, intelligent transportation, and autonomous driving, and specifically to a method for processing trajectory data and apparatus, a target event detection model training method and apparatus, an electronic device, a computer-readable storage medium, and a computer program product.

### BACKGROUND

Lane-level maps can not only accurately reflect information such as road geometry, lane lines, and traffic signs, but also dynamically monitor and analyze vehicle driving states, traffic flow, etc., providing key support for fields such as map navigation, intelligent transportation systems, and autonomous driving. Conventional lane-level map updating methods mainly rely on scheduled collection. Image information of roads is collected by means of the scheduled collection method, and after image recognition, the lane-level map is updated.

Methods described in this section are not necessarily methods that have been previously conceived or employed. It should not be assumed that any of the methods described in this section is considered to be prior art just because they are included in this section, unless otherwise indicated expressly. Similarly, the problem mentioned in this section should not be considered to be universally recognized in any prior art, unless otherwise indicated expressly.

### SUMMARY

The present disclosure provides a method for processing trajectory data and apparatus, a target event detection model training method and apparatus, an electronic device, a computer-readable storage medium, and a computer program product.

According to an aspect of the present disclosure, a method for processing trajectory data is provided. The method includes: obtaining trajectory data, wherein the trajectory data comprises vehicle trajectory information on a target road segment within a target historical time period, wherein the target historical time period comprises a plurality of sub-time periods, and wherein the target road segment comprises a plurality of road sections; obtaining a first distribution encoding of the target road segment and a speed encoding of the target road segment based on the trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; and obtaining a target detection result based on the first distribution encoding and the speed encoding, wherein the target detection result indicates whether a target road event occurs in the target road segment.

According to another aspect of the present disclosure, a target event detection model training method is provided. The method includes: obtaining sample trajectory data and a sample label corresponding to the sample trajectory data, wherein the sample trajectory data comprises vehicle trajectory information on a sample road segment within a sample time period, wherein the sample time period comprises a plurality of sub-time periods, and wherein the sample road segment comprises a plurality of road sections, and wherein the sample label indicates whether a target road event occurs in the sample road segment; obtaining a first distribution encoding of the sample road segment and a speed encoding of the sample road segment based on the sample trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; inputting the first distribution encoding and the speed encoding into a target event detection model to obtain a target detection result output by the target event detection model; and adjusting at least one parameter of the target event detection model based on the target detection result and the sample label.

According to another aspect of the present disclosure, an electronic device is provided. The electronic device includes: a memory storing one or more programs configured to be executed by one or more processors, the one or more programs including instructions for performing operations comprising: obtaining trajectory data, wherein the trajectory data comprises vehicle trajectory information on a target road segment within a target historical time period, wherein the target historical time period comprises a plurality of sub-time periods, and wherein the target road segment comprises a plurality of road sections; obtaining a first distribution encoding of the target road segment and a speed encoding of the target road segment based on the trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; and obtaining a target detection result based on the first distribution encoding and the speed encoding, wherein the target detection result indicates whether a target road event occurs in the target road segment.

It should be understood that the content described in this section is not intended to identify critical or important features of the embodiments of the present disclosure, and is not intended to limit the scope of the present disclosure. Other features of the present disclosure will be readily understood with reference to the following description.

### BRIEF DESCRIPTIONS OF THE DRAWINGS

The accompanying drawings show example embodiments and form a part of the specification, and are used to explain example implementations of the embodiments together with the written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2 is a flowchart of a method for processing trajectory data according to an embodiment of the present disclosure;

FIG. 3 is a schematic diagram illustrating road section partitioning according to an example embodiment of the present disclosure;

FIG. 4 is a schematic diagram illustrating trajectory distribution encoding according to an example embodiment of the present disclosure;

FIG. 5 is a schematic diagram illustrating speed encoding according to an example embodiment of the present disclosure;

FIG. 6 is a flowchart of obtaining a first distribution encoding and a speed encoding of a target road segment according to an embodiment of the present disclosure;

FIG. 7 is a flowchart of obtaining a fused feature according to an embodiment of the present disclosure;

FIG. 8 is a schematic structural diagram of a target event detection model according to an example embodiment of the present disclosure;

FIG. 9 is a flowchart of a target event detection model training method according to an embodiment of the present disclosure;

FIG. 10 is a structural block diagram of a trajectory data processing apparatus according to an embodiment of the present disclosure;

FIG. 11 is a structural block diagram of a target event detection model training apparatus according to an embodiment of the present disclosure; and

FIG. 12 is a structural block diagram of an example electronic device that can be used to implement an embodiment of the present disclosure.

### DETAILED DESCRIPTION OF THE EMBODIMENTS

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of the listed terms.

The embodiments of the present disclosure will be described below in detail with reference to the accompanying drawings.

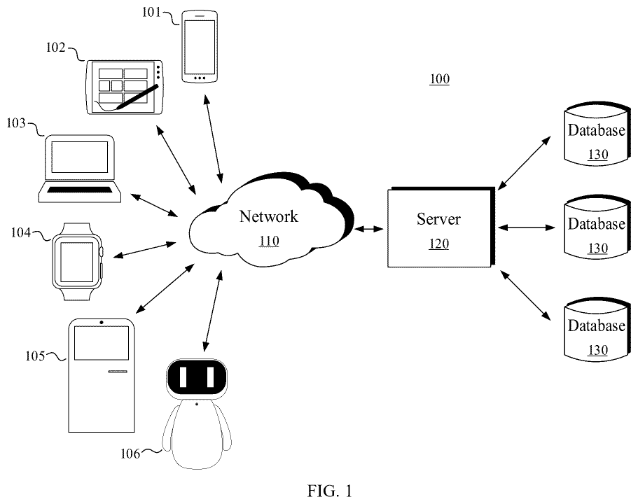

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In the embodiment of the present disclosure, the server 120 may run one or more services or software applications that enable a method for processing trajectory data or a target event detection model training method of the present disclosure to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software-as-a-service (Saas) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client device 101, 102, 103, 104, 105, and/or 106 to obtain or upload trajectory data. The client device may provide an interface that enables the user of the client device to interact with the client device. The client device may further output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE iOS, a UNIX-like operating system, and a Linux or Linux-like operating system (e.g., GOOGLE Chrome OS), or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any one of the above-mentioned operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and/or 106. The server 120 may further include one or more applications to display the data feeds and/or real-time events via one or more display devices of the client devices 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may further be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

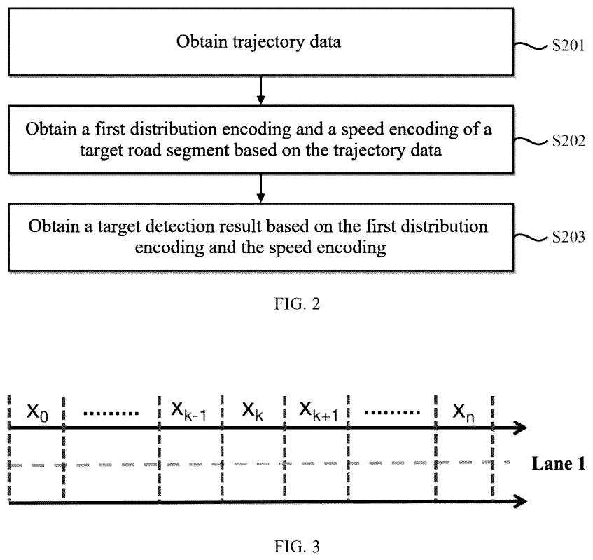

According to an embodiment of the present disclosure, as shown in FIG. 2, a method for processing trajectory data is provided, including the following steps. Step S201: Obtain trajectory data, wherein the trajectory data comprises vehicle trajectory information on a target road segment within a target historical time period, wherein the target historical time period comprises a plurality of sub-time periods, and wherein the target road segment comprises a plurality of road sections. Step S202: Obtain a first distribution encoding of the target road segment and a speed encoding of the target road segment based on the trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods. Step S203: Obtain a target detection result based on the first distribution encoding and the speed encoding, wherein the target detection result indicates whether a target road event occurs in the target road segment.

Thus, by separately encoding the trajectory data in two dimensions, namely the trajectory distribution dimension and the speed dimension, rich feature information in the trajectory data can be extracted, and then target road event detection is performed based on the distribution encoding and the speed encoding, which can improve the accuracy of target road event detection.

The trajectory data may include trajectory information of all vehicles passing through the target road segment within the target historical time period, and the vehicle trajectory information may include spatio-temporal data during vehicle travel, for example, each piece of vehicle trajectory information may include times at which the vehicle passes through different positions in the target road segment.

In some embodiments, the target historical time period may be a preset time period counted backward from the current moment, for example, the last 12 hours, one day, or one week. It can be understood that a person skilled in the relevant art can determine the target historical time period according to actual requirements, which is not limited herein.

In some embodiments, obtaining the first distribution encoding and the speed encoding of the target road segment based on the trajectory data may be implemented in the following manner.

FIG. 3 is a schematic diagram showing road section partitioning according to an example embodiment of the present disclosure.

First, the target road segment may be evenly partitioned into a plurality of road sections. As shown in the example given in FIG. 3, the target road segment may be evenly partitioned into n road sections (X₁, . . . , Xₙ), and trajectories are distributed in each road section of the target road segment. At the same time, the target historical time period is evenly partitioned into a plurality of sub-time periods, where the section length of each road section and the duration of each sub-time period may be determined according to actual requirements, which are not limited herein.

Subsequently, based on the trajectory data, for each road section within each sub-time period, a count of trajectories (n) on the road section within the sub-time period and an average vehicle speed (v) corresponding to the passing trajectories on the road section may be counted, so as to obtain the first distribution encoding and the speed encoding. The average vehicle speed corresponding to the road section within the sub-time period may be determined by first calculating a vehicle traveling speed of each trajectory passing through the road section within the sub-time period, and then calculating an average of a plurality of vehicle traveling speeds corresponding to a plurality of trajectories.

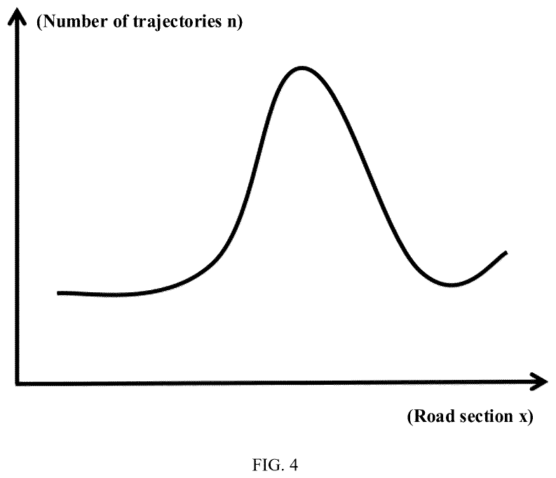

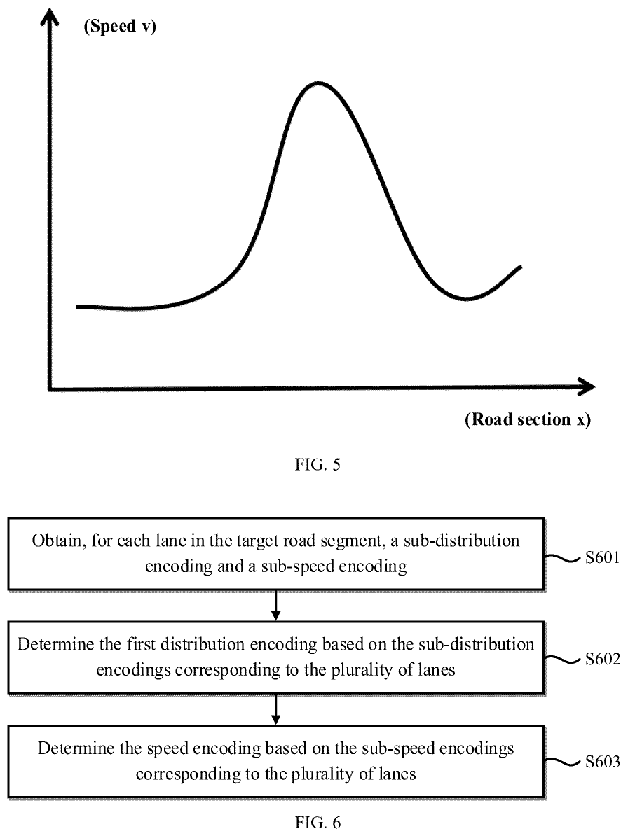

FIG. 4 and FIG. 5 are schematic diagrams of trajectory distribution encoding and speed encoding according to example embodiments of the present disclosure, respectively. In FIG. 4, the curve may represent characteristics of trajectory distribution on different road sections within a certain sub-time period, and in FIG. 5, the curve may represent a change in the average vehicle speed on different road sections within a certain sub-time period.

In some embodiments, the first distribution encoding and the speed encoding may be represented as three-dimensional vectors. As an example, the first distribution encoding may be represented as a three-dimensional vector D(t×n×x), i.e., including a count of trajectories on each of the plurality of road sections within each of the plurality of sub-time periods, and the speed encoding may be represented as a three-dimensional vector V(t×v×x), i.e., including an average vehicle speed for each of the plurality of road sections within each of the plurality of sub-time periods.

Thus, by encoding the vehicle trajectory data into three-dimensional vectors, a feasible and effective encoding method is provided for deep learning-based target road event detection. The aforementioned encoding method can effectively extract key information from vehicle trajectories, thereby achieving accurate subsequent detection of target road events.

In some embodiments, after the aforementioned first distribution encoding and speed encoding are obtained, they may be input together into a trained target event detection model, so that the target event detection model outputs a target detection result after analyzing the encoded information. In some example embodiments, the target event detection model may include a feature extraction network and an output network. The feature extraction network may first perform feature extraction on the first distribution encoding and the speed encoding, so as to obtain a hidden layer representation of the aforementioned encoded information, and then input it into the output network to obtain the target detection result.

The target detection result may be used to indicate whether a target road event occurs in the target road segment. The target road event may include, for example, road rerouting, changes in road markings or a number of lanes, construction or an accident occurring in the target road segment within the target historical time period, or the like.

In some embodiments, the aforementioned trajectory data may be lane-level trajectory data, meaning that the positioning accuracy of the trajectory data is at a lane level; for example, the positioning accuracy may be less than 1 m.

In some embodiments, the target road segment may include one lane or a plurality of lanes, and the first distribution encoding and the speed encoding may be obtained by using the method described above.

In some embodiments, as shown in FIG. 6, the target road segment may include a plurality of lanes, and obtaining the first distribution encoding and the speed encoding of the target road segment based on the trajectory data may include the following steps. Step S601: Obtain, for each lane in the target road segment, a sub-distribution encoding and a sub-speed encoding corresponding to the lane, where the sub-distribution encoding includes a count of trajectories on each of the plurality of road sections of the corresponding lane within each of the plurality of sub-time periods, and the sub-speed encoding includes an average vehicle speed for each of the plurality of road sections of the corresponding lane within each of the plurality of sub-time periods. Step S602: Determine the first distribution encoding based on the sub-distribution encodings corresponding to the plurality of lanes. Step S603: Determine the speed encoding based on the sub-speed encodings corresponding to the plurality of lanes.

In some embodiments, when the target road segment includes a plurality of lanes, for each lane, a distribution encoding and a speed encoding of vehicle trajectories on the lane may be obtained by a manner similar to that described above, as the sub-distribution encoding and the sub-speed encoding corresponding to the lane. Subsequently, the first distribution encoding of the target road segment may be determined based on the plurality of sub-distribution encodings respectively corresponding to the plurality of lanes, and the speed encoding of the target road segment may be determined based on the plurality of sub-speed encodings respectively corresponding to the plurality of lanes.

In some embodiments, the plurality of sub-distribution encodings may be concatenated into a single encoding to obtain the first distribution encoding. Similarly, the plurality of sub-speed encodings may be concatenated into a single encoding to obtain the speed encoding. In some embodiments, the first distribution encoding may also be obtained by adding the plurality of sub-distribution encodings, and the speed encoding may be obtained by adding the plurality of sub-speed encodings. It can be understood that a person skilled in the relevant art can determine the manner of obtaining the first distribution encoding and the speed encoding according to actual requirements, which is not limited herein.

Thus, in a case where the target road segment contains a plurality of lanes, by further splitting and encoding the trajectory data according to different lanes, richer local road features can be obtained, thereby further improving the accuracy of target road event detection.

In addition, the trajectory data typically contains rich feature information, but not all information is useful for detecting a specific target event, and there may also be noise or information irrelevant to detection of the specific target event. By encoding the trajectory data, noise data can also be removed to a certain extent, thereby also improving the accuracy of subsequent target road event detection.

In some embodiments, obtaining the target detection result based on the first distribution encoding and the speed encoding may include: performing self-attention mechanism-based feature extraction on the first distribution encoding to obtain a first distribution feature; performing self-attention mechanism-based feature extraction on the speed encoding to obtain a first speed feature; and obtaining the target detection result based on the first distribution feature and the first speed feature.

In some embodiments, performing self-attention mechanism-based feature extraction on the first distribution encoding and performing self-attention mechanism-based feature extraction on the speed encoding may be implemented by a first feature extraction network and a second feature extraction network in a target event detection model, respectively. The first feature extraction network and the second feature extraction network may be each a self-attention mechanism-based feature extraction network.

In some example embodiments, the first feature extraction network may include an embedding layer and one or more transformer encoders, where the encoders may each adopt a structure of a self-attention encoder. The second feature extraction network may also adopt a structure similar to that of the first feature extraction network.

After the first distribution encoding and the speed encoding are respectively input into the first feature extraction network and the second feature extraction network, they are first input into the embedding layer. Through the transformation in the embedding layer, the original discrete input data is transformed and mapped to a high-dimensional vector space, thereby obtaining an intermediate vector capable of more comprehensively describing trajectory information. Subsequently, the intermediate vector output by the embedding layer is input into the self-attention encoder. The self-attention encoder calculates an attention weight for each position in the intermediate vector, and outputs the first distribution feature and the first speed feature, enabling the model to give different degrees of attention to information for different positions in the intermediate vector when processing the input data.

In some embodiments, obtaining the target detection result based on the first distribution feature and the first speed feature may be: inputting the first distribution feature and the first speed feature into an output network in the target event detection model, and obtaining the target detection result through analysis by the output network. The output network may be a single-layer or multi-layer fully connected network.

Thus, by first performing self-attention mechanism-based feature extraction separately on the first distribution encoding and the speed encoding, key information in the first distribution encoding and the speed encoding can be further extracted, and then detection of the target road event is performed based on the extracted features, which can further improve the accuracy of target road event detection.

For different road scenes, using only local trajectory distribution encodings and local speed encodings of different lanes cannot enable the model to accurately capture distinctions between different road scenes (for example, a scene with a wide road and many lanes versus a scene with a narrow road and few lanes), and the accuracy of target road event detection cannot be further improved.

Through experiments, it has been found that an overall number of road trajectories on the target road segment has important reference value for target road event detection in different scenes.

In some embodiments, the aforementioned method for processing trajectory data may further include: obtaining a second distribution encoding of the target road segment based on the trajectory data, where the second distribution encoding includes a count of trajectories on the target road segment within each of the plurality of sub-time periods; and where obtaining the target detection result based on the first distribution feature and the first speed feature may include: obtaining the target detection result based on the first distribution feature, the first speed feature, and the second distribution encoding.

The second distribution encoding contains a total count of trajectories passing through the target road segment within each of the plurality of sub-time periods.

In some embodiments, obtaining the target detection result based on the first distribution feature, the first speed feature, and the second distribution encoding may be: inputting the first distribution feature, the first speed feature, and the second distribution encoding into the output network in the target event detection model, and obtaining the target detection result through analysis by the output network. The output network may be a single-layer or multi-layer fully connected network.

Thus, while analyzing local features of the plurality of lanes, a global feature on an overall road dimension of the target road segment (i.e., the second distribution encoding) is further introduced, achieving comprehensive analysis of local features and global features of the trajectory data of the target road segment, making it possible to more accurately identify dynamic changes in different scenes, thereby providing more comprehensive and precise support for classification, prediction, and pattern recognition of complex scenes, and further improving the accuracy of target road event detection.

In some embodiments, obtaining the target detection result based on the first distribution feature, the first speed feature, and the second distribution encoding may include: performing cross-attention mechanism-based feature fusion on the first distribution feature, the first speed feature, and the second distribution encoding to obtain a fused feature; and obtaining the target detection result based on the fused feature.

In some embodiments, the aforementioned output network may further include a feature fusion network and an output sub-network. The feature fusion network may be configured to perform cross-attention mechanism-based feature fusion.

In some embodiments, performing cross-attention mechanism-based feature fusion on the first distribution feature, the first speed feature, and the second distribution encoding to obtain the fused feature may be: inputting the aforementioned three into the feature fusion network, so that the feature fusion network performs cross-attention mechanism-based feature fusion and outputs the fused feature.

In some embodiments, in the feature fusion network, cross-attention mechanism-based feature fusion (where one or more cross-attention decoders are applied, for example) may be performed on the first distribution feature and the second distribution encoding to obtain an intermediate fused feature, and further feature fusion, for example, feature concatenation or feature addition, may be performed on the intermediate fused feature and the first speed feature to obtain the fused feature.

In some embodiments, in the feature fusion network, cross-attention mechanism-based feature fusion (where one or more cross-attention decoders are applied, for example) may also be performed on the first speed feature and the second distribution encoding to obtain an intermediate fused feature, and further feature fusion, for example, feature concatenation or feature addition, may be performed on the intermediate fused feature and the first distribution feature to obtain the fused feature.

In some embodiments, obtaining the target detection result based on the fused feature may be: inputting the fused feature into the output sub-network in the output network, and obtaining the target detection result through analysis by the output sub-network. The output sub-network may be a single-layer or multi-layer fully connected network.

Thus, by applying a cross-attention mechanism to perform feature fusion on the first distribution feature, the first speed feature, and the second distribution encoding, intrinsic associations between local features and global features in speed and trajectory distribution can be further extracted, and then detection of the target road event is performed based on the extracted features, which can further improve the accuracy of target road event detection.

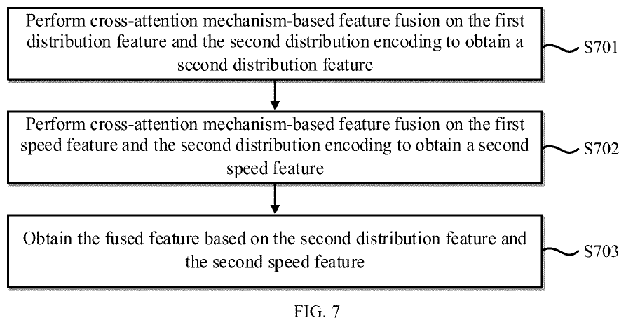

In some embodiments, as shown in FIG. 7, performing cross-attention mechanism-based feature fusion on the first distribution feature, the first speed feature, and the second distribution encoding to obtain the fused feature may include the following steps. Step S701: Perform cross-attention mechanism-based feature fusion on the first distribution feature and the second distribution encoding to obtain a second distribution feature. Step S702: Perform cross-attention mechanism-based feature fusion on the first speed feature and the second distribution encoding to obtain a second speed feature. Step S703: Obtain the fused feature based on the second distribution feature and the second speed feature.

In some embodiments, the aforementioned feature fusion network may include a first fusion sub-network, a second fusion sub-network, and a third fusion sub-network. The first fusion sub-network and the second fusion sub-network may be each a cross-attention mechanism-based feature fusion network.

In some example embodiments, the first fusion sub-network may include one or more transformer decoders, where the decoders may each adopt a structure of a cross-attention decoder. The second fusion sub-network may also adopt a structure similar to that of the first fusion sub-network.

In some embodiments, the third fusion sub-network may be configured to perform feature fusion on the second distribution feature and the second speed feature. For example, the second distribution feature and the second speed feature may be concatenated or added to obtain the fused feature. In some embodiments, the third fusion sub-network may also adopt a structure similar to that of the first fusion sub-network, performing feature fusion on the second distribution feature and the second speed feature based on the cross-attention mechanism.

Thus, by respectively applying cross-attention mechanism-based feature fusion to the first distribution feature and the second distribution encoding and to the first speed feature and the second distribution encoding, intrinsic associations between local features and global features of speed and trajectory distribution can be respectively obtained, enabling effective feature interaction and fusion in temporal and spatial dimensions between the global information, i.e., the overall number of trajectories on the target road segment, and the local features of trajectory distribution and speed. On this basis, further performing detection of the target road event based on the extracted second distribution feature and second speed feature can further improve the accuracy of target road event detection.

In some embodiments, to enable better cross-attention mechanism-based feature fusion to be performed between the second distribution encoding and the first speed feature or the first distribution feature, dimension unification is required for the second distribution encoding and the first speed feature or the first distribution feature. As an example, the second distribution encoding may be represented as a two-dimensional vector D(t×w), i.e., the number of trajectories passing through the target road segment within each sub-time period. To unify vector dimensions, the two-dimensional vector may be expanded dimensionally. For example, D(t×w) may be replicated x times to expand it into D(t×w×x), where the x dimension may be the road section dimension.

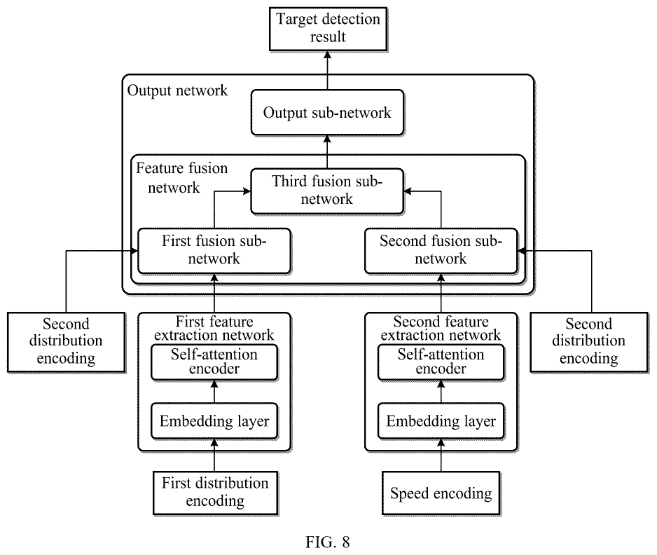

FIG. 8 is a schematic structural diagram of a target event detection model according to an example embodiment of the present disclosure.

According to an example embodiment of the present disclosure, as shown in FIG. 8, the first distribution encoding may be input into a first feature extraction network and pass through an embedding layer and one or more self-attention encoders to obtain a first distribution feature, and the speed encoding may be input into a second feature extraction network and pass through an embedding layer and one or more self-attention encoders to obtain a first speed feature; subsequently, the first distribution feature and the second distribution encoding are input into a first fusion sub-network, and the first speed feature and the second distribution encoding are input into a second fusion sub-network, thereby respectively obtaining a second distribution feature and a second speed feature, where the first fusion sub-network and the second fusion sub-network may each include one or more cross-attention decoders; after the second distribution feature and the second speed feature are input into a third fusion sub-network for feature fusion, a fused feature is obtained; and finally, the fused feature is input into an output sub-network, and a target detection result output by the output sub-network can be obtained. The first distribution encoding, the second distribution encoding, and the speed encoding may be obtained by any of the manners described above.

Thus, by encoding trajectory data in a local dimension and a global dimension, and through a combination of a self-attention mechanism and a cross-attention mechanism, effective mining of trajectory distribution features and speed features of the target road segment is achieved. This fully extracts feature information related to target event detection contained in the trajectory data. Performing target road event detection on this basis can greatly improve the accuracy of target road event detection.

In some embodiments, the target road segment corresponds to a target road link in a map, and the method for processing trajectory data of the present disclosure may further include: updating, in response to the target detection result indicating that the target road event occurs in the target road segment, map data corresponding to the target road link.

In some embodiments, the aforementioned target road segment may be a certain target road link in a map (e.g., a lane-level map), and the target road event may be a road event that may cause a map update, including but not limited to a change in the number of lanes on the target road link, lane rerouting caused by an accident or construction occurring on the target road link, a change in road markings on the target road link, etc.

In some embodiments, the aforementioned target event detection model may include a plurality of output sub-networks, and each output sub-network may correspond to a different target task, including but not limited to outputting a change amount in the number of lanes on the target road link, determining whether an accident or construction occurs on the target road link, determining whether road markings on the target road link change, etc.

Thus, by performing target road event detection based on trajectory data for a target road link in a map, whether the target road link requires a map update can be determined more accurately and efficiently, thereby enabling map data to be updated more promptly and accurately.

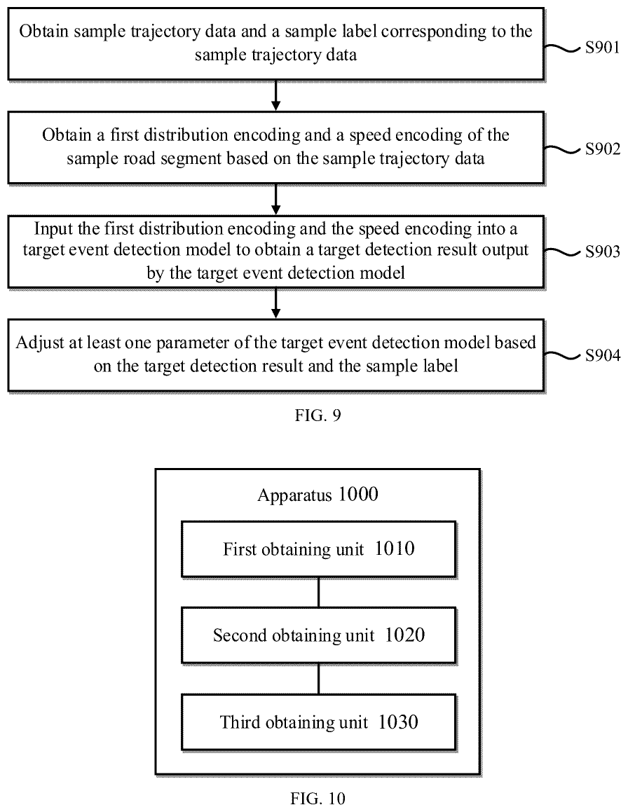

In some embodiments, as shown in FIG. 9, a target event detection model training method is further disclosed, including the following steps. Step S901: Obtain sample trajectory data and a sample label corresponding to the sample trajectory data, wherein the sample trajectory data comprises vehicle trajectory information on a sample road segment within a sample time period, wherein the sample time period comprises a plurality of sub-time periods, and wherein the sample road segment comprises a plurality of road sections, and wherein the sample label indicates whether a target road event occurs in the sample road segment. Step S902: Obtain a first distribution encoding of the sample road segment and a speed encoding of the sample road segment based on the sample trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods. Step S903: Input the first distribution encoding and the speed encoding into a target event detection model to obtain a target detection result output by the target event detection model. Step S904: Adjust at least one parameter of the target event detection model based on the target detection result and the sample label.

The target event detection model obtained by training through the aforementioned model training method may be configured to perform the aforementioned method for processing trajectory data of the present disclosure. By separately encoding the trajectory data in two dimensions, namely the trajectory distribution dimension and the speed dimension, rich feature information in the trajectory data can be extracted, and then the distribution encoding and the speed encoding are input into the target event detection model for detection of the target road event, which can improve the accuracy of target road event detection.

In some embodiments, the aforementioned target event detection model may adopt any one of the model structures described above, which will not be described in detail herein.

In some embodiments, the target event detection model includes a first feature extraction network, a second feature extraction network, and an output network, and inputting the first distribution encoding and the speed encoding into the target event detection model to obtain the target detection result output by the target event detection model may include: performing self-attention mechanism-based feature extraction on the first distribution encoding using the first feature extraction network to obtain a first distribution feature; performing self-attention mechanism-based feature extraction on the speed encoding using the second feature extraction network to obtain a first speed feature; and inputting at least the first distribution feature and the first speed feature into the output network to obtain the target detection result output by the output network.

The first feature extraction network, the second feature extraction network, and the output network are similar to the first feature extraction network, the second feature extraction network, and the output network described above, and will not be described in detail herein.

In some embodiments, the sample road segment may include a plurality of lanes, and obtaining the first distribution encoding and the speed encoding of the sample road segment based on the sample trajectory data may include: obtaining, for each lane in the sample road segment, a sub-distribution encoding and a sub-speed encoding corresponding to the lane, where the sub-distribution encoding includes a count of trajectories on each of the plurality of road sections of the corresponding lane within each of the plurality of sub-time periods, and the sub-speed encoding includes an average vehicle speed for each of the plurality of road sections of the corresponding lane within each of the plurality of sub-time periods; determining the first distribution encoding based on the sub-distribution encodings corresponding to the plurality of lanes; and determining the speed encoding based on the sub-speed encodings corresponding to the plurality of lanes.

In some embodiments, the aforementioned model training method may further include: obtaining a second distribution encoding of the sample road segment based on the sample trajectory data, where the second distribution encoding includes a count of trajectories on the sample road segment within each of the plurality of sub-time periods; and inputting at least the first distribution feature and the first speed feature into the output network to obtain the target detection result output by the output network may include: inputting the first distribution feature, the first speed feature, and the second distribution encoding into the output network to obtain the target detection result output by the output network.

In some embodiments, the output network may include a feature fusion network and an output sub-network, and inputting the first distribution feature, the first speed feature, and the second distribution encoding into the output network to obtain the target detection result output by the output network may include: performing cross-attention mechanism-based feature fusion on the first distribution feature, the first speed feature, and the second distribution encoding using the feature fusion network to obtain a fused feature; and inputting the fused feature into the output sub-network to obtain the target detection result output by the output sub-network.

The feature fusion network and the output sub-network are respectively similar to the feature fusion network and the output sub-network described above, and will not be described in detail herein.

In some embodiments, the feature fusion network may include a first fusion sub-network, a second fusion sub-network, and a third fusion sub-network, and performing cross-attention mechanism-based feature fusion on the first distribution feature, the first speed feature, and the second distribution encoding using the feature fusion network to obtain the fused feature may include: performing cross-attention mechanism-based feature fusion on the first distribution feature and the second distribution encoding using the first fusion sub-network to obtain a second distribution feature; performing cross-attention mechanism-based feature fusion on the first speed feature and the second distribution encoding using the second fusion sub-network to obtain a second speed feature; and performing feature fusion on the second distribution feature and the second speed feature using the third fusion sub-network to obtain the fused feature.

The first fusion sub-network, the second fusion sub-network, and the third fusion sub-network are respectively similar to the first fusion sub-network, the second fusion sub-network, and the third fusion sub-network described above, and will not be described in detail herein.

In some embodiments, as shown in FIG. 10, an apparatus 1000 for processing trajectory data is further provided, including: a first obtaining unit 1010 configured to obtain trajectory data, wherein the trajectory data comprises vehicle trajectory information on a target road segment within a target historical time period, wherein the target historical time period comprises a plurality of sub-time periods, and wherein the target road segment comprises a plurality of road sections; a second obtaining unit 1020 configured to obtain a first distribution encoding of the target road segment and a speed encoding of the target road segment based on the trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; and a third obtaining unit 1030 configured to obtain a target detection result based on the first distribution encoding and the speed encoding, wherein the target detection result indicates whether a target road event occurs in the target road segment.

Operations performed by the aforementioned units 1010 to 1030 in the trajectory data processing apparatus 1000 and achievable effects are similar to steps S201 to S203 in the method for processing trajectory data described above, and will not be described in detail herein.

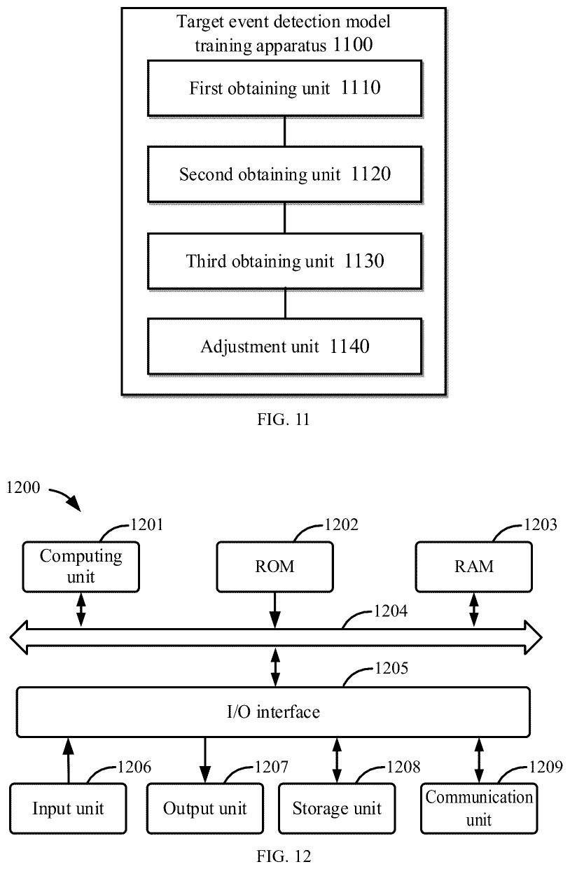

In some embodiments, as shown in FIG. 11, a target event detection model training apparatus 1100 is further provided, including: a first obtaining unit 1110 configured to obtain sample trajectory data and a sample label corresponding to the sample trajectory data, wherein the sample trajectory data comprises vehicle trajectory information on a sample road segment within a sample time period, wherein the sample time period comprises a plurality of sub-time periods, and wherein the sample road segment comprises a plurality of road sections, and wherein the sample label indicates whether a target road event occurs in the sample road segment; a second obtaining unit 1120 configured to obtain a first distribution encoding of the sample road segment and a speed encoding of the sample road segment based on the sample trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; a third obtaining unit 1130 configured to input the first distribution encoding and the speed encoding into a target event detection model to obtain a target detection result output by the target event detection model; and an adjustment unit 1140 configured to adjust at least one parameter of the target event detection model based on the target detection result and the sample label.

Operations performed by the aforementioned units 1110 to 1140 in the target event detection model training apparatus 1100 described above and achievable effects are similar to steps S901 to S904 in the target event detection model training method described above, and will not be described in detail herein.

In the technical solutions of the present disclosure, collection, storage, use, processing, transmission, provision, disclosure, etc. of user personal information involved all comply with related laws and regulations and are not against the public order and good morals.

According to embodiments of the present disclosure, an electronic device, a readable storage medium, and a computer program product are further provided.

Referring to FIG. 12, a structural block diagram of an electronic device 1200 will be described below, which can serve as a server or a client of the present disclosure and is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 12, the electronic device 1200 includes a computing unit 1201, the computing unit may perform various appropriate actions and processing according to a computer program stored in a read-only memory (ROM) 1202 or a computer program loaded from a storage unit 1208 to a random access memory (RAM) 1203. The RAM 1203 may further store various programs and data required for the operation of the electronic device 1200. The computing unit 1201, the ROM 1202, and the RAM 1203 are connected to each other through a bus 1204. An input/output (I/O) interface 1205 is also connected to the bus 1204.

A plurality of components in the electronic device 1200 are connected to the I/O interface 1205, including: an input unit 1206, an output unit 1207, the storage unit 1208, and a communication unit 1209. The input unit 1206 may be any type of device capable of inputting information to the electronic device 1200, the input unit 1206 may receive input digit or character information and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1207 may be any type of device capable of presenting information, and may include, but is not limited to, a display, a speaker, a video/audio output terminal, a vibrator, and/or a printer. The storage unit 1208 may include, but is not limited to, a magnetic disk and an optical disk. The communication unit 1209 allows the electronic device 1200 to exchange information/data with other devices via a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMax device, and/or a cellular communication device.

The computing unit 1201 may be various general-purpose and/or special-purpose processing components with processing and computing capabilities. Some examples of the computing unit 1201 include, but are not limited to, a central processing unit (CPU), a graphics processing unit (GPU), various dedicated artificial intelligence (AI) computing chips, various computing units on which machine learning model algorithms run, a digital signal processor (DSP), and any appropriate processor, controller, microcontroller, etc. The computing unit 1201 performs the various methods and processing described above, for example, the method for processing trajectory data or the model training method described above. For example, in some embodiments, the method for processing trajectory data or the model training method described above may be implemented as a computer software program, which is tangibly contained in a machine-readable medium, such as the storage unit 1208. In some embodiments, a part or all of the computer program may be loaded and/or installed onto the electronic device 1200 via the ROM 1202 and/or the communication unit 1209. When the computer program is loaded onto the RAM 1203 and executed by the computing unit 1201, one or more steps of the method for processing trajectory data or the model training method described above can be performed. Alternatively, in other embodiments, the computing unit 1201 may be configured, by any other suitable means (for example, by means of firmware), to perform the method for processing trajectory data or the model training method described above.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logic device (CPLD), computer hardware, firmware, software, and/or a combination thereof. These various implementations may include implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input means, and at least one output means, and transmit data and instructions to the storage system, the at least one input apparatus, and the at least one output means.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing means (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system including a backend component (for example, as a data server), in a computing system including a middleware component (for example, an application server), in a computing system including a frontend component (for example, a user computer with a graphical user interface or a web browser through which the user can interact with the implementation of the systems and technologies described herein), or in a computing system including any combination of the backend component, the middleware component, and the frontend component. The components of the system can be connected to each other through digital data communication (for example, a communication network) in any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, successively, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present disclosure is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A method for processing trajectory data, comprising:
obtaining trajectory data, wherein the trajectory data comprises vehicle trajectory information on a target road segment within a target historical time period, wherein the target historical time period comprises a plurality of sub-time periods, and wherein the target road segment comprises a plurality of road sections;
obtaining a first distribution encoding of the target road segment and a speed encoding of the target road segment based on the trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; and
obtaining a target detection result based on the first distribution encoding and the speed encoding, wherein the target detection result indicates whether a target road event occurs in the target road segment.

2. The method according to claim 1, wherein the obtaining the target detection result based on the first distribution encoding and the speed encoding comprises:
performing self-attention mechanism-based feature extraction on the first distribution encoding to obtain a first distribution feature;
performing self-attention mechanism-based feature extraction on the speed encoding to obtain a first speed feature; and
obtaining the target detection result based on the first distribution feature and the first speed feature.

3. The method according to claim 2, wherein the target road segment comprises a plurality of lanes, and wherein the obtaining the first distribution encoding of the target road segment and the speed encoding of the target road segment based on the trajectory data comprises:
obtaining, for each lane of the plurality of lanes, a sub-distribution encoding and a sub-speed encoding, wherein the sub-distribution encoding comprises a count of trajectories on each road section of the plurality of road sections of the lane within each sub-time period of the plurality of sub-time periods, and wherein the sub-speed encoding comprises an average vehicle speed for each road section of the plurality of road sections of the lane within each sub-time period of the plurality of sub-time periods;
determining the first distribution encoding based on the sub-distribution encodings corresponding to the plurality of lanes; and
determining the speed encoding based on the sub-speed encodings corresponding to the plurality of lanes.

4. The method according to claim 3, further comprising:
obtaining a second distribution encoding of the target road segment based on the trajectory data, wherein the second distribution encoding comprises a count of trajectories on the target road segment within each sub-time period of the plurality of sub-time periods; and
wherein the obtaining the target detection result based on the first distribution feature and the first speed feature comprises:
obtaining the target detection result based on the first distribution feature, the first speed feature, and the second distribution encoding.

5. The method according to claim 4, wherein the obtaining the target detection result based on the first distribution feature, the first speed feature, and the second distribution encoding comprises:
performing cross-attention mechanism-based feature fusion on the first distribution feature, the first speed feature, and the second distribution encoding to obtain a fused feature; and
obtaining the target detection result based on the fused feature.

6. The method according to claim 5, wherein the performing cross-attention mechanism-based feature fusion on the first distribution feature, the first speed feature, and the second distribution encoding to obtain the fused feature comprises:
performing cross-attention mechanism-based feature fusion on the first distribution feature and the second distribution encoding to obtain a second distribution feature;
performing cross-attention mechanism-based feature fusion on the first speed feature and the second distribution encoding to obtain a second speed feature; and
obtaining the fused feature based on the second distribution feature and the second speed feature.

7. The method according to claim 1, wherein the target road segment corresponds to a target road link in a map, and wherein the method further comprises:
updating, in response to the target detection result indicating that the target road event occurs in the target road segment, map data corresponding to the target road link.

8. A target event detection model training method, comprising:
obtaining sample trajectory data and a sample label corresponding to the sample trajectory data, wherein the sample trajectory data comprises vehicle trajectory information on a sample road segment within a sample time period, wherein the sample time period comprises a plurality of sub-time periods, and wherein the sample road segment comprises a plurality of road sections, and wherein the sample label indicates whether a target road event occurs in the sample road segment;
obtaining a first distribution encoding of the sample road segment and a speed encoding of the sample road segment based on the sample trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods;
inputting the first distribution encoding and the speed encoding into a target event detection model to obtain a target detection result output by the target event detection model; and
adjusting at least one parameter of the target event detection model based on the target detection result and the sample label.

9. The method according to claim 8, wherein the target event detection model comprises a first feature extraction network, a second feature extraction network, and an output network, and wherein the inputting the first distribution encoding and the speed encoding into the target event detection model to obtain the target detection result output by the target event detection model comprises:
performing self-attention mechanism-based feature extraction on the first distribution encoding using the first feature extraction network to obtain a first distribution feature;
performing self-attention mechanism-based feature extraction on the speed encoding using the second feature extraction network to obtain a first speed feature; and
inputting at least the first distribution feature and the first speed feature into the output network to obtain the target detection result output by the output network.

10. The method according to claim 9, further comprising:
obtaining a second distribution encoding of the sample road segment based on the sample trajectory data, wherein the second distribution encoding comprises a count of trajectories on the sample road segment within each sub-time period of the plurality of sub-time periods; and
wherein the inputting at least the first distribution feature and the first speed feature into the output network to obtain the target detection result output by the output network comprises:
inputting the first distribution feature, the first speed feature, and the second distribution encoding into the output network to obtain the target detection result output by the output network.

11. The method according to claim 10, wherein the output network comprises a feature fusion network and an output sub-network, and wherein the inputting the first distribution feature, the first speed feature, and the second distribution encoding into the output network to obtain the target detection result output by the output network comprises:
performing cross-attention mechanism-based feature fusion on the first distribution feature, the first speed feature, and the second distribution encoding using the feature fusion network to obtain a fused feature; and
inputting the fused feature into the output sub-network to obtain the target detection result output by the output sub-network.

12. The method according to claim 11, wherein the feature fusion network comprises a first fusion sub-network, a second fusion sub-network, and a third fusion sub-network, and wherein the performing cross-attention mechanism-based feature fusion on the first distribution feature, the first speed feature, and the second distribution encoding using the feature fusion network to obtain the fused feature comprises:
performing cross-attention mechanism-based feature fusion on the first distribution feature and the second distribution encoding using the first fusion sub-network to obtain a second distribution feature;
performing cross-attention mechanism-based feature fusion on the first speed feature and the second distribution encoding using the second fusion sub-network to obtain a second speed feature; and
performing feature fusion on the second distribution feature and the second speed feature using the third fusion sub-network to obtain the fused feature.

13. An electronic device, comprising:
a memory storing one or more programs configured to be executed by one or more processors, the one or more programs including instructions for performing operations comprising:
obtaining trajectory data, wherein the trajectory data comprises vehicle trajectory information on a target road segment within a target historical time period, wherein the target historical time period comprises a plurality of sub-time periods, and wherein the target road segment comprises a plurality of road sections;
obtaining a first distribution encoding of the target road segment and a speed encoding of the target road segment based on the trajectory data, wherein the first distribution encoding comprises a count of trajectories on each road section of the plurality of road sections within each sub-time period of the plurality of sub-time periods, and wherein the speed encoding comprises an average vehicle speed for each road section of the plurality of road sections within each sub-time period of the plurality of sub-time periods; and
obtaining a target detection result based on the first distribution encoding and the speed encoding, wherein the target detection result indicates whether a target road event occurs in the target road segment.

14. The electronic device according to claim 13, wherein the obtaining the target detection result based on the first distribution encoding and the speed encoding comprises:
performing self-attention mechanism-based feature extraction on the first distribution encoding to obtain a first distribution feature;
performing self-attention mechanism-based feature extraction on the speed encoding to obtain a first speed feature; and
obtaining the target detection result based on the first distribution feature and the first speed feature.

15. The electronic device according to claim 14, wherein the target road segment comprises a plurality of lanes, and wherein the obtaining the first distribution encoding of the target road segment and the speed encoding of the target road segment based on the trajectory data comprises:
obtaining, for each lane of the plurality of lanes, a sub-distribution encoding and a sub-speed encoding, wherein the sub-distribution encoding comprises a count of trajectories on each road section of the plurality of road sections of the lane within each sub-time period of the plurality of sub-time periods, and wherein the sub-speed encoding comprises an average vehicle speed for each road section of the plurality of road sections of the lane within each sub-time period of the plurality of sub-time periods;
determining the first distribution encoding based on the sub-distribution encodings corresponding to the plurality of lanes; and
determining the speed encoding based on the sub-speed encodings corresponding to the plurality of lanes.

16. The electronic device according to claim 15, wherein the operations further comprise:
obtaining a second distribution encoding of the target road segment based on the trajectory data, wherein the second distribution encoding comprises a count of trajectories on the target road segment within each sub-time period of the plurality of sub-time periods; and
wherein the obtaining the target detection result based on the first distribution feature and the first speed feature comprises:
obtaining the target detection result based on the first distribution feature, the first speed feature, and the second distribution encoding.

17. The electronic device according to claim 16, wherein the obtaining the target detection result based on the first distribution feature, the first speed feature, and the second distribution encoding comprises:
performing cross-attention mechanism-based feature fusion on the first distribution feature, the first speed feature, and the second distribution encoding to obtain a fused feature; and
obtaining the target detection result based on the fused feature.

18. The electronic device according to claim 17, wherein the performing cross-attention mechanism-based feature fusion on the first distribution feature, the first speed feature, and the second distribution encoding to obtain the fused feature comprises:
performing cross-attention mechanism-based feature fusion on the first distribution feature and the second distribution encoding to obtain a second distribution feature;
performing cross-attention mechanism-based feature fusion on the first speed feature and the second distribution encoding to obtain a second speed feature; and
obtaining the fused feature based on the second distribution feature and the second speed feature.

19. The electronic device according to claim 13, wherein the target road segment corresponds to a target road link in a map, and wherein the method further comprises:
updating, in response to the target detection result indicating that the target road event occurs in the target road segment, map data corresponding to the target road link.
